(19) United States
(12) Patent Application Publication
(10) Pub. No.: US 2018/0013163 A1
(43) Pub. Date: Jan. 11, 2018

(54) METHOD FOR PREPARING ELECTROLYTE FOR REDOX FLOW BATTERY INCLUDING ORGANIC MOLECULE AS ADDITIVE AND REDOX FLOW BATTERY USING THE SAME

(71) Applicant: KOREA INSTITUTE OF SCIENCE AND TECHNOLOGY, Seoul (KR)

(72) Inventors: Jinyeon HWANG, Seoul (KR); Heung Yong HA, Seoul (KR)

(21) Appl. No.: 15/612,399

(22) Filed: Jun. 2, 2017

(30) Foreign Application Priority Data
Jul. 5, 2016 (KR) 10-2016-0084821

(51) Int. Cl. H01M 8/18; H01M 6/16; H01M 6/04; H01M 10/0564; H01M 8/20; H01M 2/38

(52) U.S. Cl. CPC H01M 8/188; H01M 10/0564; H01M 8/20; H01M 6/168; H01M 6/04; H01M 2/38

(57) ABSTRACT

Disclosed is an electrolyte for a redox flow battery including at least one additive selected from the group consisting of a taurine compound and an amino acid compound. Thus, it is possible to provide an electrolyte for a redox flow battery which may have high solubility of active materials, be stable at high temperature or high pH, and show excellent electrochemical properties. In addition, when the electrolyte for a redox flow battery includes a nitrogen (N)-containing organic molecule having high redox activity as an active material, it is possible to realize a high-efficiency demetallized redox flow battery capable of solving the problems of dendrite formation or irreversible precipitation fundamentally.

### CROSS-REFERENCE TO RELATED APPLICATION

This application claims priority to Korean Patent Application No. 10-2016-0084821, filed on Jul. 5, 2016, and all the benefits accruing therefrom under 35 U.S.C. §119, the contents of which in its entirety are herein incorporated by reference.

### BACKGROUND

### 1. Field

The present disclosure relates to an electrolyte for a redox flow battery including an organic molecule as an additive and a method for preparing the same. More particularly, the present disclosure relates to an electrolyte for a redox flow battery including at least one additive selected from the group consisting of a taurine compound and an amino acid compound, and a method for preparing the same.

### DESCRIPTION ABOUT NATIONAL SUPPORT RESEARCH AND DEVELOPMENT

This study is made by the support of Korea Ministry of Trade, Industry and Energy under the supervision of LG Chem. Ltd. and the research subject title is ‘Development of Selective Ion Transfer Material for energy storage Redox Flow Battery (RFB)’ (Subject Identification No.: 1415143403).

### 2. Description of the Related Art

As large-capacity energy storage devices have been in increasing demand, studies about redox flow batteries have been accelerated. A redox flow battery is capable of charging and discharging electric energy according to oxidation and reduction of an active material dissolved in an aqueous or organic electrolyte. Herein, the energy density of a redox flow battery depends on the solubility of active materials. However, the solubility of active materials is limited. Particularly, when a redox flow battery is operated at high temperature or high pH, side reactions such as an irreversible precipitation and gas generation may occur. Thus, oxidation and reduction of active materials are limited, resulting in degradation of the efficiency and the capacity of a battery. Moreover, since a crossover phenomenon in which active redox materials or water molecules in the electrolyte pass through a separator and moves toward the opposite electrolyte may occur, the performance of a battery may be degraded significantly. In addition, some active materials such as metal ions may undergo irregular growth on the surface of electrode of a battery so as to form dendrites. As a result, the electrochemical activity of an electrolyte may be degraded gradually and the redox flow battery may be deteriorated with ease. For these reasons, the development of efficient electrolyte is needed to overcome the current problems in redox flow batteries.

### SUMMARY

The present disclosure is directed to providing an electrolyte for a redox flow battery which may show higher solubility of an active material than the known solubility limit and have high energy density and excellent electrochemical activity, and a method for preparing the same.

In addition, the present disclosure is directed to providing an electrolyte for a redox flow battery which may be stable without side reactions such as an irreversible precipitation and gas generation even at high temperature or high pH when a battery is operated and thus may show long-term stability, and a method for preparing the same.

Further, the present disclosure is directed to providing an electrolyte for a redox flow battery which may help to realize a high-efficiency demetallized redox flow battery, and a method for preparing the same.

In one aspect, there is provided an electrolyte for a redox flow battery which includes at least one additive selected from the group consisting of a taurine compound and an amino acid compound.

According to an embodiment, the taurine compound may be a C0-C10 hydrocarbon compound having an amine group and a sulfonic acid group as functional groups.

According to another embodiment, the amino acid compound may include at least one of an amino acid and an amino acid derivative.

According to still another embodiment, the amino acid may be α-amino acid, β-amino acids or γ-amino acid, and the amino acid derivative is a derivative of the amino acid which has a substituent containing at least one element selected from the group consisting of nitrogen (N) and sulfur (S) at the side chain thereof through ionic bonding or covalent bonding.

According to still another embodiment, the amino acid derivative may be a hydrocarbon compound having an imidazole ring or a heteroaromatic ring including a C5-C9 aromatic ring, at least two carbon (C) atoms of which are substituted with at least one element selected from the group consisting of nitrogen (N), oxygen (O) and sulfur (S).

According to still another embodiment, the heteroaromatic ring may be pyrazolium, oxazolium, triazolium, thiazolium or pyrimidine.

According to still another embodiment, the electrolyte for a redox flow battery may be an electrolyte for a redox flow battery based on an aqueous or non-aqueous solvent and further comprising a metal ion active material or an organic molecule active material. The additive may form a complex ion with the metal ion active material or organic molecule active material.

According to still another embodiment, the organic molecule active material may include at least one selected from the group consisting of flavin, a flavin derivative, a vitamin, a vitamin derivative, purine, a purine derivative, nicotinamide and phthalocyanine.

According to still another embodiment, the flavin derivative may be a compound of riboflavin, pteridine, isoalloxazine, alloxazine, lumichrome or lumazine, or the compound to which at least one heteroatom selected from the group consisting of carbon (C), nitrogen (N), oxygen (O) and sulfur (S) is attached through ionic bonding or covalent bonding.

According to still embodiment, the vitamin may be vitamin A, vitamin B, vitamin C, vitamin D, vitamin E or vitamin K. The vitamin derivative may be the vitamin to which at least one heteroatom selected from the group consisting of carbon (C), nitrogen (N), oxygen (O) and sulfur (S) is attached through ionic bonding or covalent bonding.

According to yet another embodiment, the purine derivative may be a purine to which at least one heteroatom selected from the group consisting of carbon (C), nitrogen (N), oxygen (O) and sulfur (S) is attached through ionic bonding or covalent bonding.

In another aspect, there is provided a method for preparing an electrolyte for a redox flow battery, which includes: forming a first electrolyte in which an active material is dissolved; and adding at least one additive selected from the group consisting of a taurine compound and an amino acid compound to the first electrolyte to form a second electrolyte.

According to an embodiment, the second electrolyte may be supplied to a redox flow battery. Then, the redox flow battery may be charged or discharged.

According to another embodiment, the redox flow battery may be a unit cell, a half cell, a cell having asymmetric electrodes, a large-scale cell or a stack cell with large capacity.

According to still another embodiment, the additive may form a complex ion with the active material in the second electrolyte.

The electrolyte for a redox flow battery disclosed herein includes a taurine compound and/or an amino acid compound and thus has high solubility of an active material. As a result, it is possible to provide a redox flow battery having high energy density and electrochemical activity.

In addition, the electrolyte for a redox flow battery disclosed herein may be stable when a battery is operated, particularly at high temperature or high pH. Thus, even when a redox flow battery is operated for a long time, the electrolyte may cause no irreversible precipitation and gas generation, thereby providing excellent stability. Additionally, a crossover phenomenon may be reduced.

Further, the electrolyte for a redox flow battery disclosed herein includes an organic molecule having high redox activity and containing a nitrogen (N) atom as an active material, and has no metal ions. Therefore, it is possible to realize a high-efficiency demetallized redox flow battery capable of solving the problems of dendrite formation or precipitation fundamentally.

### BRIEF DESCRIPTION OF THE DRAWINGS

FIG. 1 shows a binding structure of an additive with an active material to form a complex ion according to an example embodiment.

FIG. 2 shows a structure of a redox flow battery applicable to example embodiments.

FIG. 3 is a graph illustrating the electrochemical characteristics of Examples 1, 4 and 5 and Comparative Example 1, as determined by cyclic voltammetry (CV).

FIG. 4 is a graph illustrating the electrochemical characteristics of Examples 1-5, as determined by cyclic voltammetry (CV).

FIG. 5 is a graph illustrating the electrochemical characteristics of Examples 6-10, as determined by cyclic voltammetry (CV).

FIG. 6 is a graph illustrating the electrochemical characteristics of Examples 11-13 and Comparative Example 1, as determined by cyclic voltammetry (CV).

FIG. 7 is a graph illustrating the electrochemical characteristics of Example 1, as determined by cyclic voltammetry (CV) at different scan rates.

FIG. 8 is a graph illustrating the electrochemical characteristics of Example 11, as determined by cyclic voltammetry (CV) at different scan rates.

FIG. 9 is a graph illustrating the oxidation peak current density, reduction peak current density and the potential gap of each of Examples 1 and 11 and Comparative Example 1.

FIG. 10 is a graph illustrating a change in concentration of the VO₂⁺ active material at 40° C. with time in each of the cathode electrolytes according to Examples 14-15 and Comparative Example 2.

FIG. 11 is a graph illustrating a change in battery capacity as a function of the number of charge/discharge cycles for each of the redox flow batteries using Examples 1 and 11 and Comparative Example 1.

FIG. 12 is a graph illustrating a change in battery energy as a function of the number of charge/discharge cycles for each of the redox flow batteries using Examples 1 and 11 and Comparative Example 1.

FIG. 13 is a graph illustrating the electrochemical characteristics of the first electrolyte according to Example 16, as determined by cyclic voltammetry (CV).

### DETAILED DESCRIPTION OF MAIN ELEMENTS

1, 2: Cathode and anode cells
3, 4: Cathode and anode
5: Ion exchange membrane
11, 12: Cathode and anode electrolyte tanks
13, 14: Cathode and anode pumps
15, 16: pipes

### DETAILED DESCRIPTION

Exemplary embodiments now will be described more fully hereinafter with reference to the accompanying drawings, in which exemplary embodiments are shown.

The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art.

As used herein, a redox flow battery means a battery which is designed with electrodes, electrolytes, and membrane. It stores electric energy by using the chemical redox reaction which is unique to a material and the difference thereof. Such a redox flow battery includes not only a unit cell but also a half cell, a large-scale cell and a stack cell with large capacity.

When it is said that addition of at least one additive selected from the group consisting of a taurine compound and an amino acid compound in an electrolyte, or preparation of a solution in which at least one additive selected from the group consisting of a taurine compound and an amino acid compound is included, this means that a single homogeneous solution is prepared through dissolution of a taurine compound and/or an amino acid compound homogeneously into an electrolyte for a redox flow battery.

As used herein, formation of a complex ion of at least one additive selected from the group consisting of taurine compounds and amino acid compounds with an active material means formation of a complex ion of the taurine compound and/or amino acid compound with the active material through intermolecular force in the electrolyte.

As used herein, an amino acid compound means a peptide compound wherein at least two amino acids of the same type or different types are bonded.

As used herein, occurrence of reversible redox reaction means that a stable chemical redox reaction occurs in the molecule for a long time at a specific redox potential.

As used herein, improvement of the electrochemical characteristics of an electrolyte for a redox flow battery means that more chemical species participate in reaction as the current value of each reaction increases, resulting in an increase in reaction reversibility.

As used herein, formation of irreversible precipitation means occurrence of a reaction in which some chemical species form a precipitate depending on temperature or pH when a redox flow battery is operated.

As used herein, irreversible gas generation means generation of gases caused by the degradation of electrolyte or additive. This reduces efficiency or capacity of a battery during the cell operation.

As used herein, formation of dendrite means that some chemical species grow irregularly to form crystals on the electrode, when a redox flow battery is operated.

Electrolyte for Redox Flow Battery

The electrolyte for a redox flow battery disclosed herein includes at least one additive selected from the group consisting of a taurine compound and an amino acid compound, an active material and a solvent. Herein, the nitrogen (N) and/or sulfur (S) atoms of the taurine compound and/or amino acid compound serve as ligands to provide a stable complex ion as a chelate with the active material. By virtue of the formation of such a complex ion, a new chemical equilibrium may be generated in the electrolyte, and the changed chemical equilibrium constant for complex ion formation (K_{f}) correlates with the solubility parameter (Kₛₚ), thereby generating a new dissolution equilibrium in the electrolyte (K=Kₛₚ×K_{f}). As a result, the solubility of the active material in the electrolyte may be increased.

In addition, after the complex ion formation, the active material is dissolved stably in the electrolyte. In other words, the coordinated active material is hardly decomposed or is not bound with the other redox-active ions in the electrolyte even at high temperature or high pH. Therefore, it is possible to inhibit precipitation of the active material and gas generation caused by irreversible side reactions.

Further, the ion radius of the active material forming the complex ion is increased, thereby inhibiting a crossover phenomenon in the electrolyte. Therefore, when a redox flow battery is operated, there are no problems of a sharp decrease in capacity of the battery and a change in concentration balance of the electrolyte between both electrolytes.

As a result, the electrolyte for a redox flow battery disclosed herein has high solubility of an active material and is stable even at high temperature or high pH to provide excellent energy density. Thus, when using the electrolyte disclosed herein, the redox flow battery may not undergo degradation of efficiency and capacity even when it is operated at high temperature or high pH for a long time. In other words, it is possible to realize a high-efficiency stable redox flow battery which does not require frequent exchange or reactivation by virtue of the electrolyte for a redox flow battery disclosed herein. Particularly, it is possible to manufacture redox flow batteries with large capacity by using a concentrated electrolyte, resulting in relatively small size of stack with less unit cells and cost-efficient redox flow batteries.

According to example embodiments, the taurine compound may be a C0-C10 hydrocarbon compound having an amine group and a sulfonic acid group as functional groups. Herein, the hydrocarbon compound may be an acyclic hydrocarbon compound or a cyclic hydrocarbon compound containing at least one element selected from oxygen (O), nitrogen (N), boron (B), sulfur (S), phosphorus (P), fluorine (F), iodine (I) and chlorine (Cl), in addition to carbon (C). In addition, the cyclic hydrocarbon compound may be a heterocyclic compound or an aromatic heterocyclic compound, at least one carbon (C) of which is substituted with an element such as oxygen (O), nitrogen (N), sulfur (S), phosphorus (P) or boron (B). For example, the taurine compound may be taurine, sulfamic acid or aminomethanesulfonic acid.

According to example embodiments, the amino acid compound may include at least one of an amino acid and an amino acid derivative. Thus, the amino acid compound may be a peptide compound formed through the peptide bonding, covalent bonding such as disulfide bonding, or ionic bonding between at least two amino acids of the same type or different types.

The amino acid may be α-amino acid, β-amino acid or γ-amino acid, may include a carboxyl group, amine group and hydrogen atoms around the asymmetric carbon as a central atom, and may contain a substituent having at least one of nitrogen (N) and sulfur (S) atom at the side chain thereof through ionic bonding or covalent bonding. For example, the substituent may be an aromatic ring having at least one nitrogen (N) atom, such as imidazole ring, amine group or a thiol group. Particular examples of the amino acid may include histidine, tryptophan, lysine, arginine, asparagine, glutamine, proline, cysteine, methionine, tyrosine, phenylglycine, and L-type and D-type amino acids thereof. The amino acid may be a natural amino acid, or an artificial amino acids obtained by chemical synthesis.

According to example embodiments, the amino acid derivative may be a hydrocarbon compound having at least one imidazole ring, or a heteroaromatic ring including a C3-C9 aromatic ring, at least two carbon (C) atoms of which are substituted with such elements as nitrogen (N), oxygen (O) or sulfur (S). Particular examples of the amino acid derivative may include histamine, and pyrazolium, oxazolium, triazolium, thiazolium, pyrimidine and the compound to which a functional group such as hydroxyl, carboxyl, sulfonic acid, amine, thiol, carbonyl or amide group is attached through covalent bonding. In addition, particular examples of the amino acid derivative may include a nitrogen glycoside in which a nitrogen (N) atom and carbon (C) atom are bound covalently with each other.

According to example embodiments, the additive may be used at a concentration of about 1.0 mM or more. When the additive is used at a concentration less than about 1.0 mM, it is not possible to inhibit irreversible side reactions in the electrolyte, resulting in precipitation and gas generation. Thus, the redox flow battery may provide decreased efficiency and capacity.

According to example embodiments, the active material may include metal ions or redox-active organic molecules, as long as it is capable of reversible oxidation-reduction reaction and forming a stable complex ion with the taurine compound and/or amino acid compound.

Particular examples of the metal ions may include typical metal ions, such as magnesium (Mg), aluminum (Al), phosphorus (P), sulfur (S), chlorine (Cl), calcium (Ca), gallium (Ga), germanium (Ge), arsenic (As), selenium (Se), bromine (Br), indium (In), tin (Sn), iodine (I), lead (Pb) and bismuth (Bi), or transition metal ions, such as scandium (Sc), titanium (Ti), vanadium (V), chromium (Cr), manganese (Mn), iron (Fe), cobalt (Co), nickel (Ni), copper (Cu), zinc (Zn), zirconium (Zr), molybdenum (Mo), ruthenium (Ru), palladium (Pd), silver (Ag), cadmium (Cd), tungsten (W), iridium (Ir), platinum (Pt), gold (Au), mercury (Hg) and uranium (U).

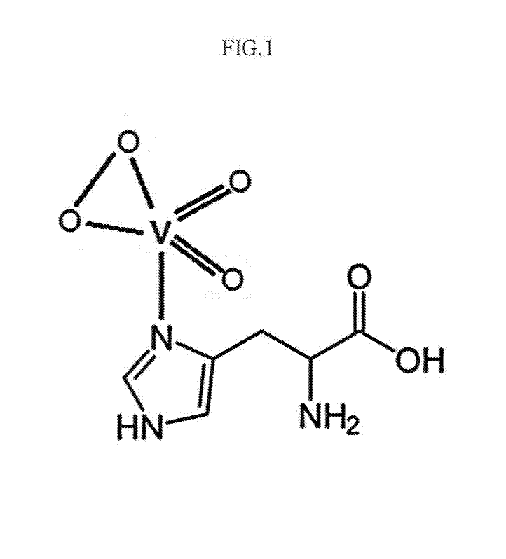

According to an embodiment, the active material may be a vanadium ion, and the additive may be histidine. In this case, the nitrogen (N) atom having lone pair electrons on the imidazole ring in histidine may form an ion-dipole intermolecular bonding with a vanadium ion. Therefore, histidine and a vanadium ion are bound and interact with each other as shown in the scheme of FIG. 1, thereby forming a thermodynamically stable complex ion.

According to an embodiment, the active material may be a vanadium ion and the additive may be cysteine. In this case, the sulfur (S) atom in the thiol group of cysteine interacts with a vanadium ion, thereby forming a thermodynamically stable complex ion.

Particular examples of the organic molecules may include quinone and derivative thereof.

Alternatively, the organic molecules may contain nitrogen (N) atoms, and particular examples thereof may include flavin and derivative thereof, vitamin and derivative thereof, purine and derivative thereof, and nicotinamide and phthalocyanine.

Flavin derivative is a compound having a fundamental flavin structure in which four nitrogen (N) atoms are present on the aromatic ring having redox activity. Particular examples thereof may include riboflavin, pteridine, isoalloxazine, alloxazine, lumichrome, lumazine and the compound to which at least one hetero element such as carbon (C), nitrogen (N), oxygen (O) or sulfur (S) is attached through ionic bonding or covalent bonding.

The vitamin may be vitamin A, vitamin B, vitamin C, vitamin D, vitamin E or vitamin K, and vitamin derivative may be the vitamin to which at least one hetero element such as carbon (C), nitrogen (N), oxygen (O) or sulfur (S) is attached through ionic bonding or covalent bonding. For example, vitamin E and derivatives thereof may be tocopherol and chromanol.

Purine derivative may be a purine to which at least one hetero element such as carbon (C), nitrogen (N), oxygen (O) or sulfur (S) is attached through ionic bonding or covalent bonding.

Many organic molecules containing nitrogen (N) atoms show a high reversibility of redox reaction Particularly, these redox molecules have a slightly lower standard reduction potential than quinone-based organic molecules. Thus, when the electrolytes including the redox-active organic molecule containing nitrogen (N) atoms are used as electrolytes for anolyte, it is possible to widen the range of operating voltage of the batteries as compared to the batteries using the electrolytes including quinone-based organic molecules. In addition, a nitrogen (N) element may induce a heteroatomic doping on the surface of an electrode during the operation of a redox flow battery. This may increase reaction sites and binding on the electrode.

Therefore, when an electrolyte for a redox flow battery includes at least one of the above-mentioned nitrogen (N)-containing organic molecules as an active material, the electrolyte may have high electrochemical activity. Without metal ions, it is possible to develop stable redox flow batteries operated at high temperature or high pH. It is also possible to solve the problems of relative low energy density in conventional redox flow batteries by multi-electron reaction mechanism in N-containing redox organic molecules.

According to example embodiments, the solvent may include at least one of aqueous solvent and organic solvent. In other words, the solvent may be an aqueous solvent or organic solvent, and optionally may be a mixed solvent of an aqueous solvent with an organic solvent, when it is required to further increase the solubility of the active material.

There is no particular limitation in the supporting materials in aqueous solvent. The particular examples of the supporting electrolytes may include at least one of sulfuric acid, hydrochloric acid, potassium hydroxide, and phosphoric acid.

There is no particular limitation in the organic solvent that may be used as the solvent, and particular examples of the organic solvent may include at least one of acetonitrile, dimethyl carbonate, diethyl carbonate, dimethyl sulfoxide, dimethyl formamide (DMF), propylene carbonate, ethylene carbonate, N-methyl-2-pyrrolidone and fluoroethylene carbonate.

Alternatively, the solvent may be an ionic liquid solvent.

Method for Preparing Electrolyte for Redox Flow Battery

The electrolyte for a redox flow battery disclosed herein may be obtained by performing the following processes.

A first electrolyte in which an active material is dissolved may be prepared.

According to example embodiments, the first electrolyte may be obtained by dissolving the active material into a solvent. According to an embodiment, the active material may be metal ions such as vanadium or the organic molecules having high redox activity and containing a nitrogen (N) atom. Thus, the first electrolyte may be prepared only with the active material without any additives

At least one additive selected from the group consisting of a taurine compound and an amino acid compound may be added to the first electrolyte to obtain a second electrolyte. Herein, the taurine compound and/or amino acid compound such as histidine may form a complex ion as a chelate with the active material in the second electrolyte. It is possible to obtain the electrolyte in which a taurine compound and/or an amino acid compound are homogeneously dissolved as organic additives. This electrolyte may be provided as a cathode electrolyte or anode electrolyte in a redox flow battery.

According to example embodiments, the taurine compound and amino acid compound may be the same as described above, and may be added to a concentration of about 1.0 mM or higher at a temperature of about −10 to 60° C.

As described above, it is possible to obtain an electrolyte for a redox flow battery with ease by adding at least one additive selected from the group consisting of a taurine compound and an amino acid compound to the first electrolyte. Particularly, the electrolyte disclosed herein may have excellent electrochemical properties, since it may increase active material solubility and reduce irreversible precipitation, gas generation and a crossover phenomenon. Further, when a nitrogen (N)-containing organic molecule having high redox activity is used as an active material, it is possible to obtain an electrolyte without any metal ions for a redox flow battery having high electrochemical activity with ease, while not causing dendrite formation and precipitation.

In a variant, the electrolyte for a redox flow battery disclosed herein may be obtained by performing substantially the same processes as described above or similar processes.

A first electrolyte and a second electrolyte may be prepared by performing substantially the same processes as described above. According to an embodiment, the first electrolyte may be prepared to have the nitrogen (N)-containing organic molecule having high redox activity as an active material. Accordingly, the second electrolyte without any metal ions may be prepared.

The second electrolyte may be supplied to a redox flow battery.

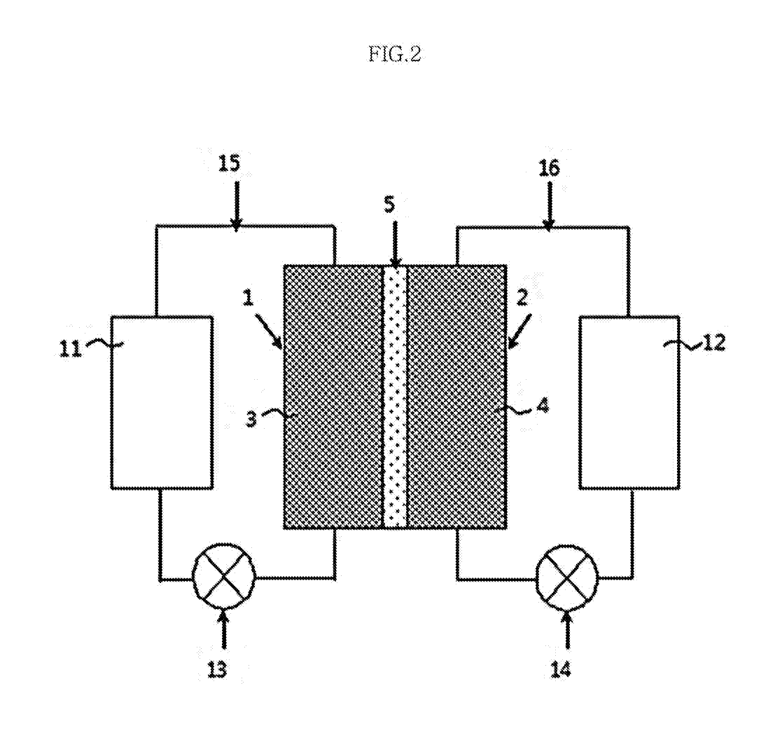

For example, the redox flow battery may be a unit cell having substantially the same structure as shown in FIG. 2 or a similar structure. Particularly, the redox flow battery may include a cathode cell 1, anode cell 2, cathode 3, anode 4, ion exchange membrane 5, cathode and anode electrolyte tanks 11, 12, cathode and anode pumps 13, 14 and pipes 15, 16. The second electrolyte may be supplied to the redox flow battery by using the cathode and anode electrolyte tanks 11, 12. Meanwhile, although it is not shown, the redox flow battery may optionally be a half cell, cell having asymmetric electrodes, large-scale cell or a stack cell with large capacity.

The redox flow battery may be charged or discharged. Thus, an additive-containing cathode electrolyte with a taurine compound and/or an amino acid compound may be produced at once at the cathode 3. Similarly, an additive-containing anode electrolyte with a taurine compound and/or an amino acid compound may also be produced at once at the anode 4. Herein, in each of the cathode and anode electrolytes, organic additives may form a complex ion as a chelate by coordination of the nitrogen (N) or sulfur (S) atoms of the taurine compound and/or amino acid compound.

The examples and experiments will now be described. The following examples and experiments are for illustrative purposes only and not intended to limit the scope of the present disclosure.

### Example 1

First, 294.2 g of sulfuric acid (H₂SO₄) was mixed with distilled water to obtain 3.0 mol/L of aqueous sulfuric acid solution with a total volume of 1.0 L. Considering a large difference in density between sulfuric acid and distilled water, the mixed solution was further mixed sufficiently for 30 minutes. Then, 244.5 g of vanadyl sulfate (VOSO₄) was added, followed by agitation for 1 hour, thereby providing a first electrolyte having a vanadium concentration of 1.5 mol/L. After that, 12.5 g of taurine was added to the first electrolyte, followed by thorough agitation, thereby providing an electrolyte for a redox flow battery having a homogeneous concentration of taurine compound of 0.10 mol/L.

### Example 2

The processes substantially the same as Example 1 were performed to obtain an electrolyte for a redox flow battery, except that 6.25 g of taurine was added to the first electrolyte, resulting in 0.05 mol/L of taurine.

### Example 3

The processes substantially the same as Example 1 were performed to obtain an electrolyte for a redox flow battery, except that 18.8 g of taurine was added to the first electrolyte, resulting in 0.15 mol/L of taurine.

### Example 4

The processes substantially the same as Example 1 were performed to obtain an electrolyte for a redox flow battery, except that 25.0 g of taurine was added to the first electrolyte, resulting in 0.20 mol/L of taurine.

### Example 5

The processes substantially the same as Example 1 were performed to obtain an electrolyte for a redox flow battery except that 37.5 g of taurine was added to the first electrolyte, resulting in 0.30 mol/L of taurine.

### Example 6

The processes substantially the same as Example 1 were performed to obtain an electrolyte for a redox flow battery, except that 4.91 g of sulfamic acid was added to the first electrolyte, resulting in 0.05 mol/L of sulfamic acid.

### Example 7

The processes substantially the same as Example 1 were performed to obtain an electrolyte for a redox flow battery, except that 9.81 g of sulfamic acid was added to the first electrolyte, resulting in 0.10 mol/L of sulfamic acid.

### Example 8

The processes substantially the same as Example 1 were performed to obtain an electrolyte for a redox flow battery, except that 14.7 g of sulfamic acid was added to the first electrolyte, resulting in 0.15 mol/L of sulfamic acid.

### Example 9

The processes substantially the same as Example 1 were performed to obtain an electrolyte for a redox flow battery, except that 19.6 g of sulfamic acid was added to the first electrolyte, resulting in 0.20 mol/L of sulfamic acid.

### Example 10

The processes substantially the same as Example 1 were performed to obtain an electrolyte for a redox flow battery, except that 29.4 g of sulfamic acid was added to the first electrolyte, resulting in 0.30 mol/L of sulfamic acid.

### Example 11

The processes substantially the same as Example 1 were performed to obtain an electrolyte for a redox flow battery, except that 15.5 g of histidine was added to the first electrolyte, resulting in 0.10 mol/L of histidine.

### Example 12

The processes substantially the same as Example 1 were performed to obtain an electrolyte for a redox flow battery, except that 31.0 g of histidine was added to the first electrolyte, resulting in 0.20 mol/L of histidine.

### Example 13

The processes substantially the same as Example 1 were performed to obtain an electrolyte for a redox flow battery, except that 46.5 g of histidine was added to the first electrolyte, resulting in 0.30 mol/L of histidine.

### Example 14

The processes substantially the same as Example 1 were performed to obtain a first electrolyte. Next, a redox flow battery was assembled as follows. Carbon felt was introduced to both a cathode and an anode and a Nafion 117 separator was inserted between them so that they were separated from each other. Each carbon felt was in contact with a graphite bipolar plate having a size of 5 cm×5 cm and a metallic current collector, respectively. Then, 12.5 g of taurine was mixed with the first electrolyte to obtain a second electrolyte having a homogeneous concentration of 0.10 mol/L of taurine and the electrolyte was allowed to flow into the redox flow battery at a flow rate of 50 mL/min. Implied current density was 50 mA/cm². After the complete charging, all vanadium ions in positive electrolyte were converted to 1.5 mol/L of VO₂⁺-type penta-valent vanadium ions having a concentration of taurine compound of 0.10 mol/L.

### Example 15

The processes substantially the same as Example 14 were performed, except that 15.5 g of histidine was mixed with the first electrolyte. In this manner, a 1.5 mol/L of VO₂⁺-type penta-valent vanadium electrolyte having a 0.10 mol/L concentration of histidine was produced at the cathode.

### Example 16

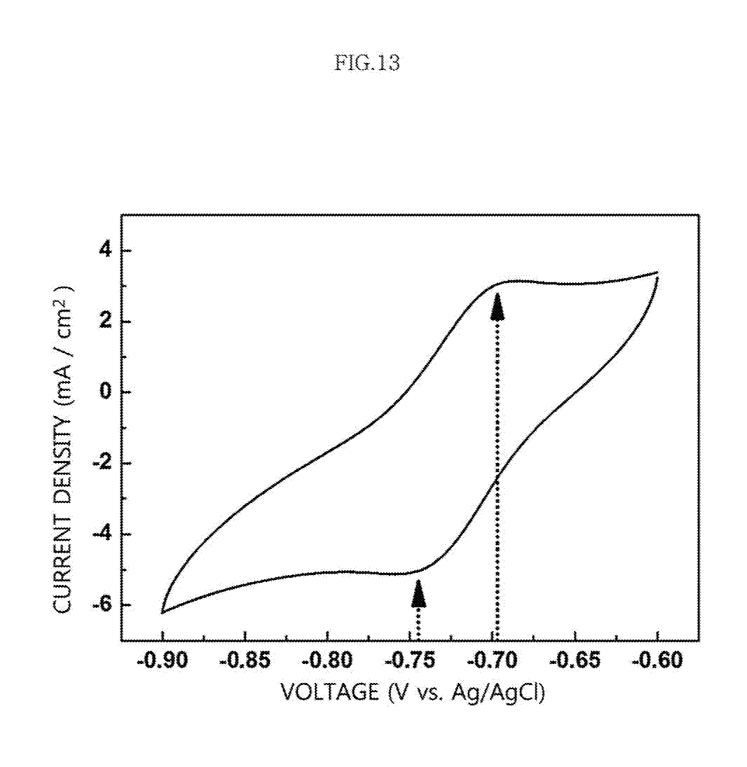

First, 0.376 g of riboflavin was mixed with 1.0 mol/L of NaOH solution to provide a homogeneous solution having a total volume of 1.0 L. The mixed solution was agitated for 1 hour to provide a first electrolyte having a riboflavin concentration of 0.001 mol/L. The obtained first electrolyte was determined for redox activity by using cyclic voltammetery (CV). The results are shown in FIG. 13.

### Comparative Example 1

The processes substantially the same as Example 1 were performed, except that no taurine compound was added. In this manner, an electrolyte for a redox flow battery containing no taurine compound or amino acid compound was obtained.

### Comparative Example 2

The processes substantially the same as Example 14 were performed, except that no taurine compound was mixed with a first electrolyte. In this manner, there is no taurine compound or amino acid compound was introduced in fully charged positive electrolyte (1.5 mol/L of VO₂⁺ penta-valent vanadium ion).

Evaluation I of Electrochemical Properties of Electrolyte for Redox Flow Battery: Concentration Dependence

To evaluate the electrochemical properties of an electrolyte for a redox flow battery depending on concentration of an additive, each of Examples 1-13 and Comparative Example 1 was subjected to cyclic voltammetry at 20 mV/sec of scan rate with a voltage range of 0.0 V-1.6 V (vs. Ag/AgCl).

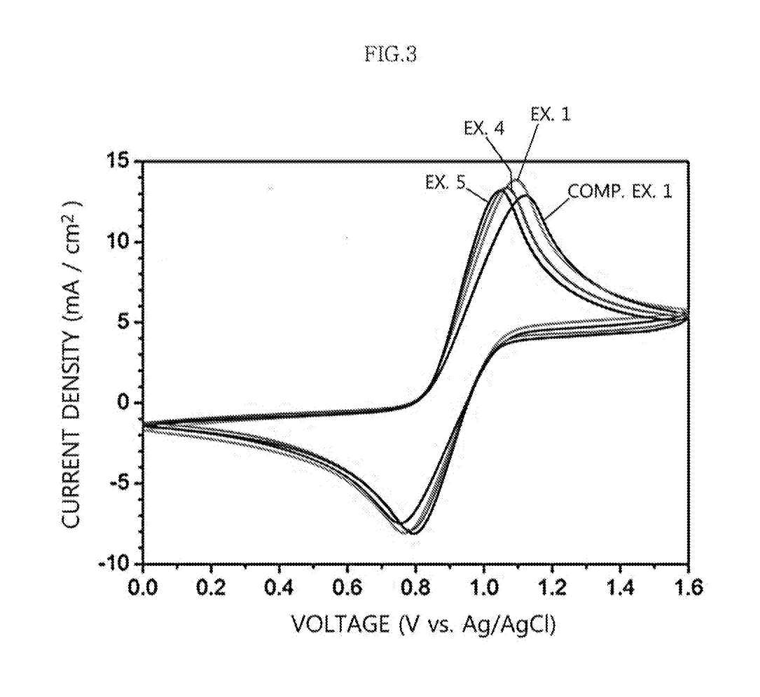

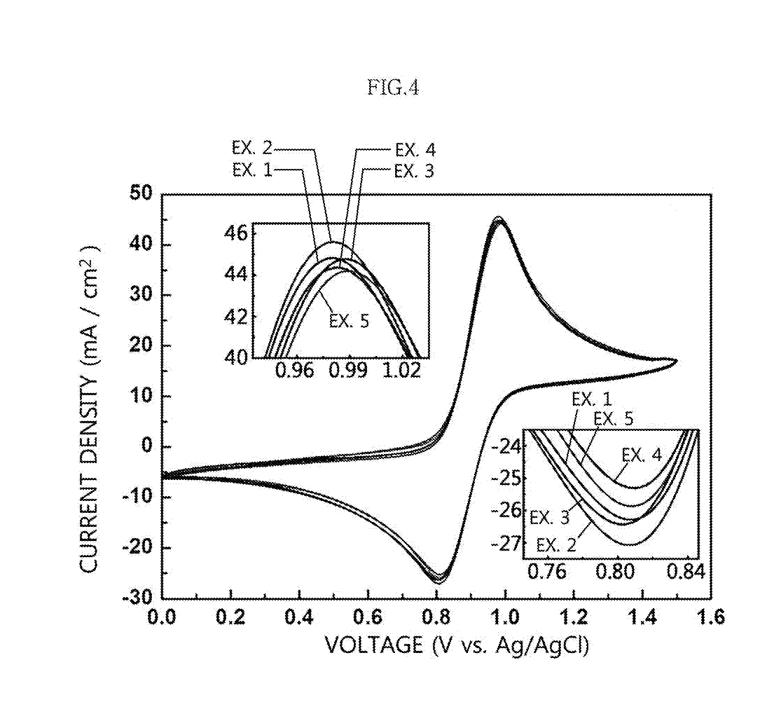

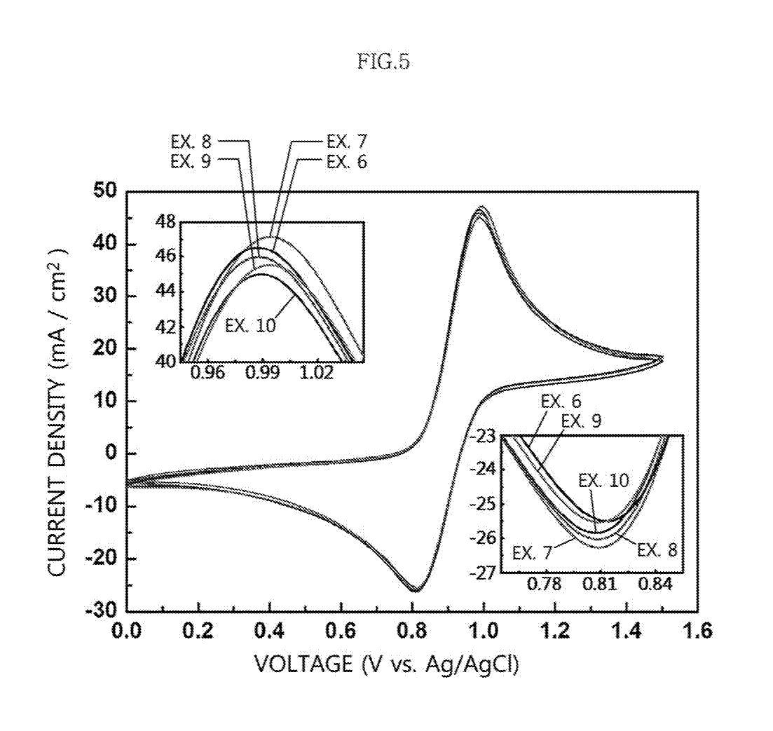

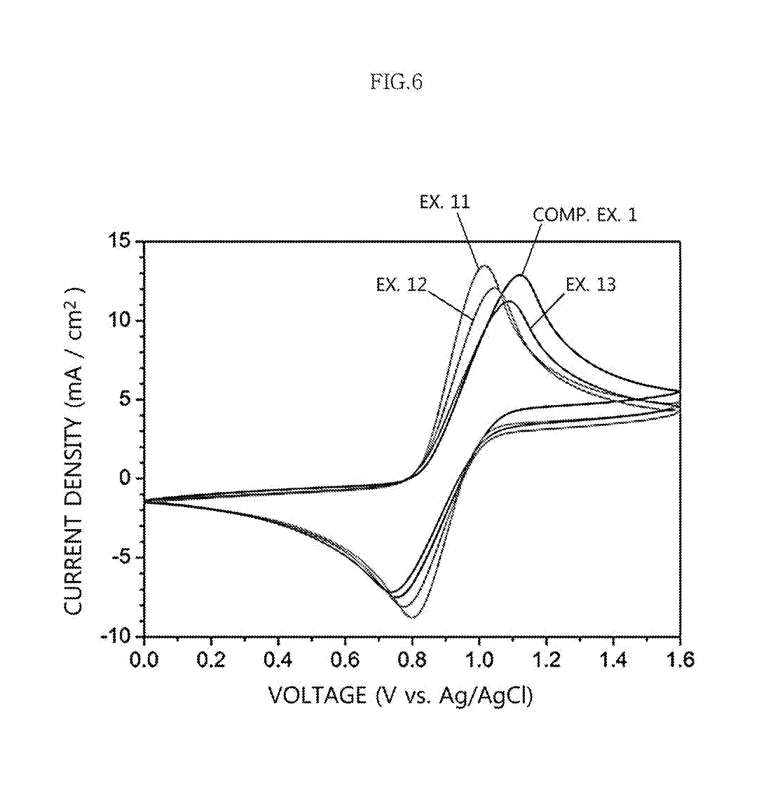

Referring to FIG. 3-FIG. 6, the current density was improved when taurine compound or an amino acid compound introduced, resulting in an increase in reversibility of oxidation-reduction reaction. Additionally, potential gap between oxidation peak and reduction peak was decreased, because the overpotential was reduced, resulting in improved voltage efficiency. Thus, at certain optimized concentration (0.10 mol/L), it was confirmed that taurine or histidine additive improved the electrochemical performance of the electrolyte for a redox flow battery.

Evaluation II of Electrochemical Properties of Electrolyte for Redox Flow Battery: Scan Rate Dependence

To evaluate the electrochemical properties of a redox flow battery depending on the scan rate, each of Examples 1 and 11 was subjected to cyclic voltammetry at different scan rate from 5 mV/sec to 100 mV/sec in a voltage range of 0.0 V-1.6 V (vs. Ag/AgCl).

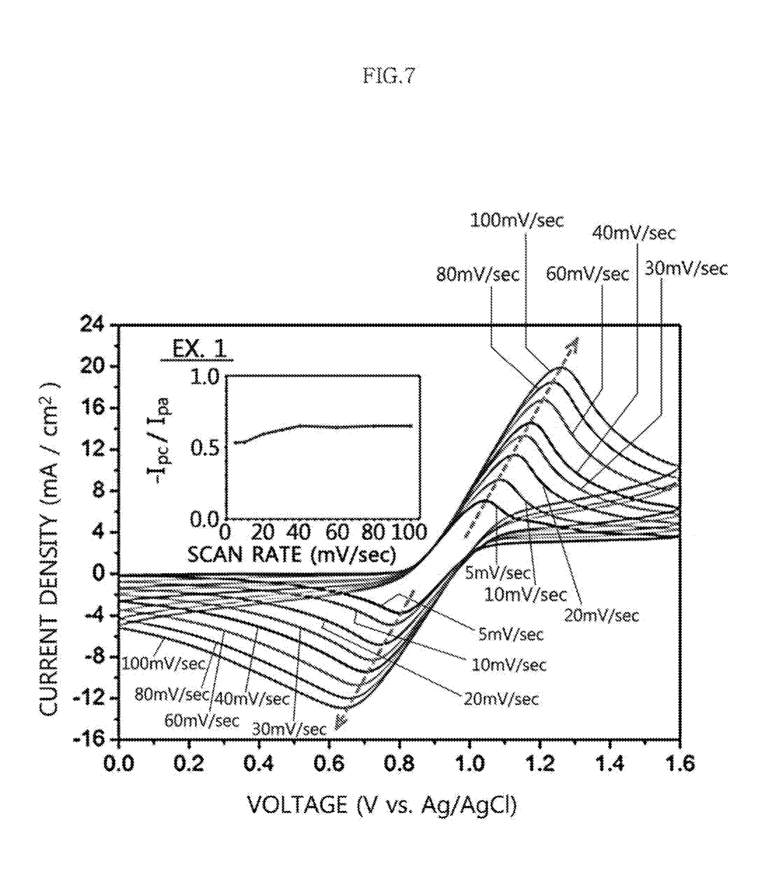

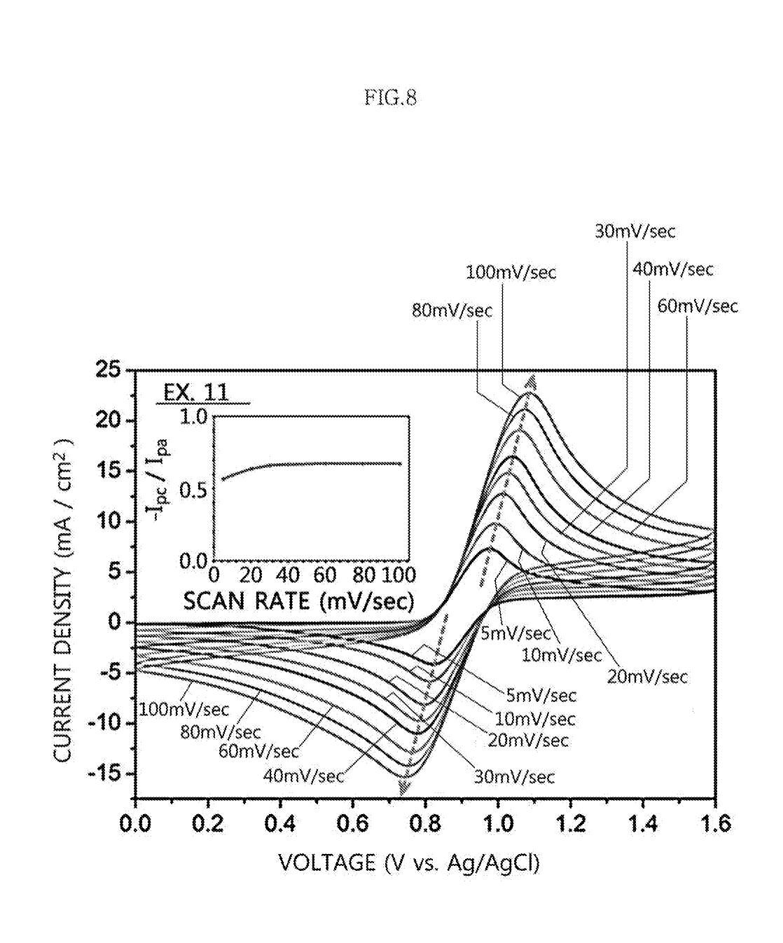

Referring to FIG. 7 and FIG. 8, it can be seen that the oxidation peak current density and reduction peak current density of an electrolyte containing taurine or histidine are proportional to the square root of scan rate, even when they are measured at different rates. Thus, it was confirmed that the electrolyte containing taurine or histidine may have stable electrochemical activity in a wide range of kinetics. It was confirmed that there is reversible oxidation-reduction reaction due to the constant I_{pc}/Iₚₐ ratio. This helps to provide an improved redox flow battery with higher current efficiency and capacity.

Evaluation III of Electrochemical Properties of Electrolyte for Redox Flow Battery: Current Density and Potential Gap Analysis

To evaluate the electrochemical properties of a redox flow battery, each of Examples 1 and 11 and Comparative Example 1 was subjected to cyclic voltammetry at 20 mV/sec of scan rate in a voltage range of 0.0 V-1.6 V (vs. Ag/AgCl) to measure the potential gap between oxidation peak and reduction peak.

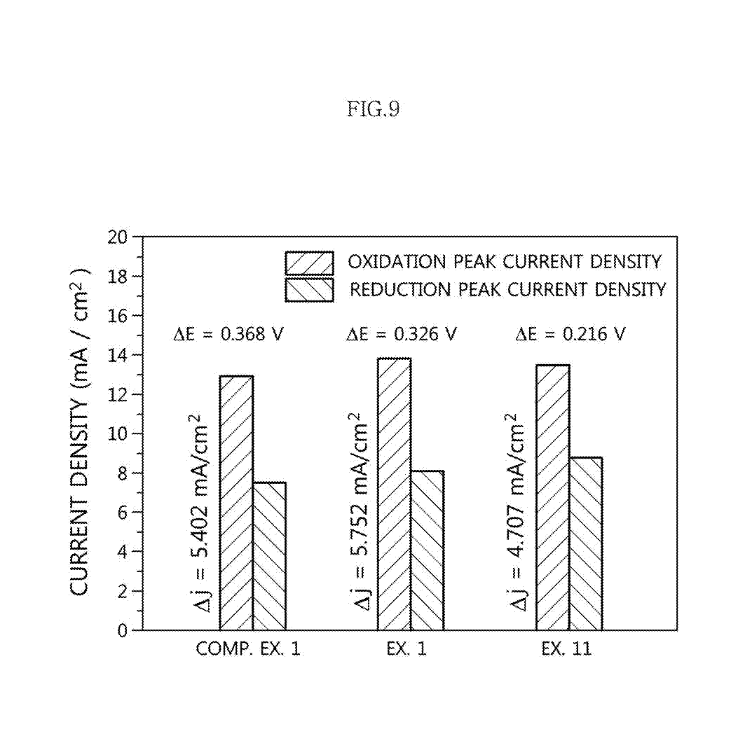

Referring to FIG. 9, Examples 1 and 11 had higher oxidation and reduction peak current density as compared to Comparative Example 1. This was due to the fact that the reaction reversibility was improved. Additionally, the potential gap between oxidation peak current density and reduction peak current density was reduced. This showed that the overpotential of the redox reaction was decreased. Thus, it was confirmed that the electrolyte for a redox flow battery containing taurine or histidine may have higher electrochemical activity, and may be used to provide an improved redox flow battery with higher voltage efficiency and capacity.

Evaluation I of Stability of Electrolyte for Redox Flow Battery: Precipitation Test

To evaluate the stability of an electrolyte for a redox flow battery, the cathode electrolyte according to each of Examples 14 and 15 and Comparative Example 2 was allowed to stand at 40° C. of constant temperature for 10 hours. The change in vanadium ion concentration in the cathode electrolyte was determined as a function of time by using UV-Visible spectroscopy.

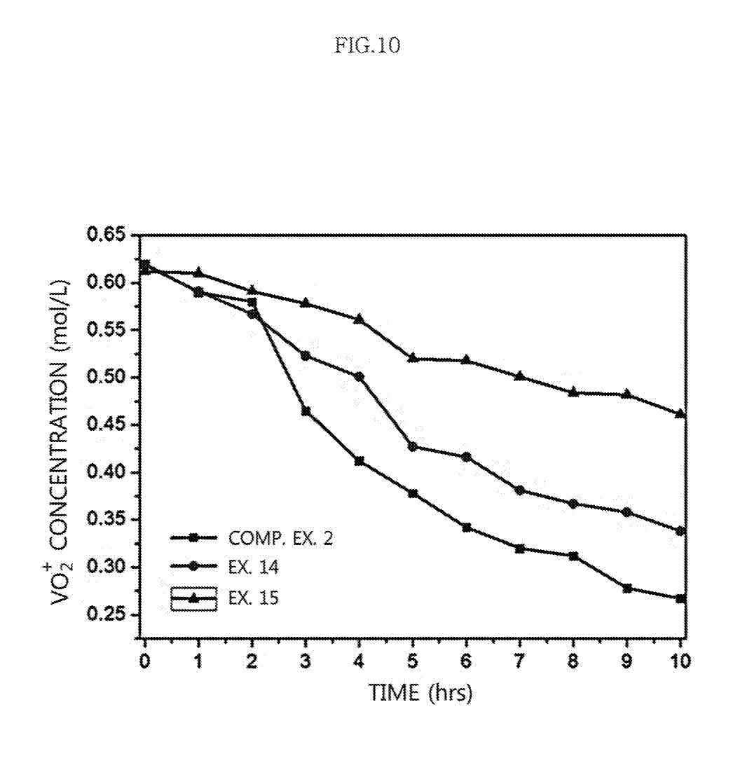

Referring to FIG. 10, the cathode electrolyte according to Comparative Example 2 caused a rapid decrease in VO₂⁺ vanadium ion concentration with the lapse of time because of the irreversible precipitation. On the other hand, the cathode electrolyte according to each of Examples 14 and 15 caused no precipitation by virtue of a gradual decrease in vanadium ion concentration with the lapse of time. Thus, it was confirmed that the electrolyte for a redox flow battery containing taurine or histidine may show improved stability of the active material therein, thereby inhibiting generation of irreversible precipitation.

Evaluation II of Stability of Electrolyte for Redox Flow Battery: Charge/Discharge Test

To evaluate the stability of an electrolyte for a redox flow battery, a change in battery capacity and energy of the redox flow battery using each of Examples 1 and 11 and Comparative Example 1 was determined as a function of the number of charge/discharge cycles.

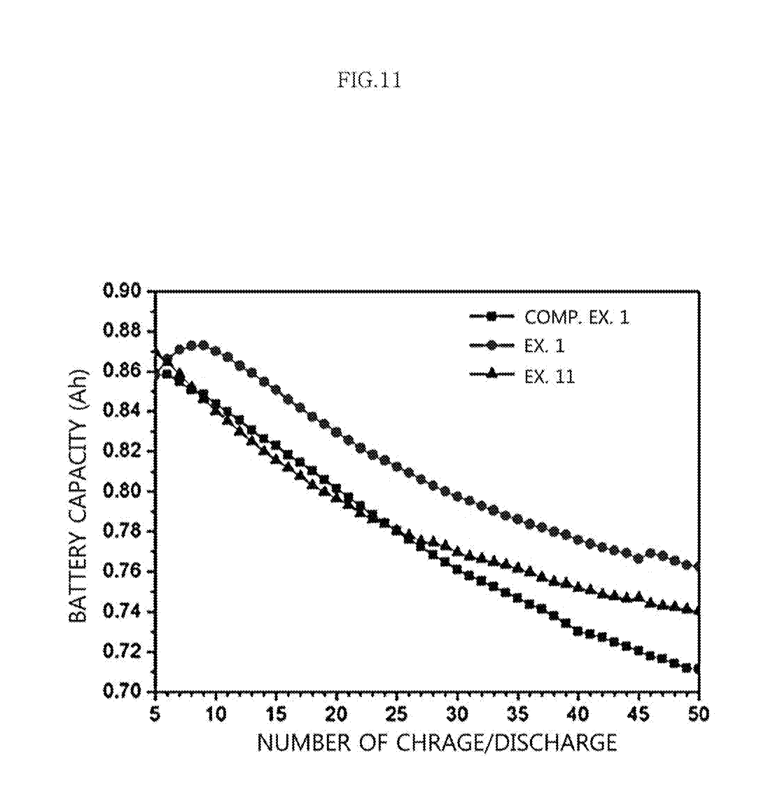

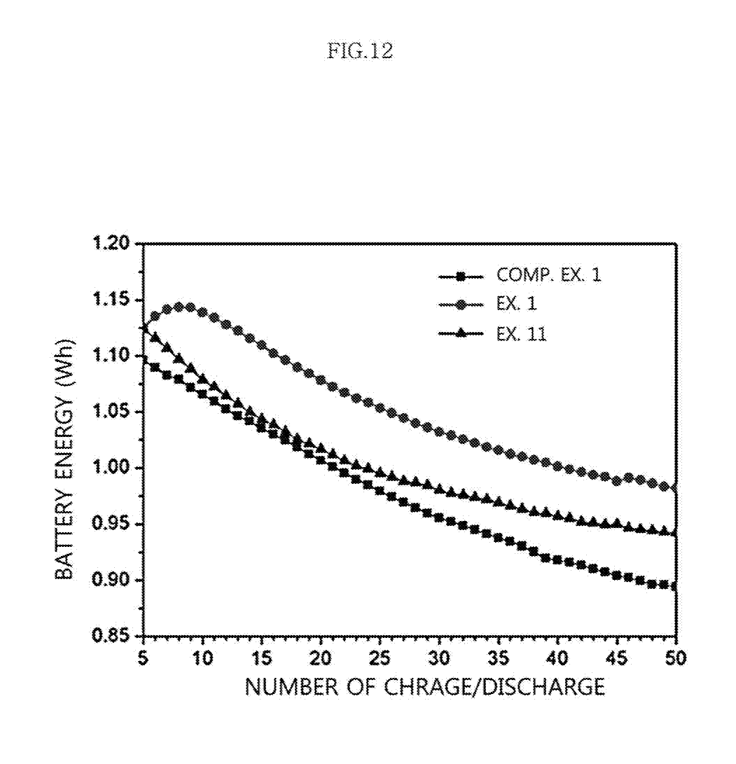

Referring to FIG. 11 and FIG. 12, the redox flow battery using each of Examples 1 and 11 showed improved performance in battery capacity and energy, as compared to the redox flow battery using Comparative Example 1. Thus, it is possible to realize a redox flow battery which may be stable during long-term operation and have high capacity or energy retention rate by using taurine and/or histidine additive.

What is claimed is:

1. An electrolyte for a redox flow battery comprising at least one additive selected from the group consisting of a taurine compound and an amino acid compound.

2. The electrolyte for a redox flow battery according to claim 1, wherein the taurine compound is a C0-C10 hydrocarbon compound having an amine group and a sulfonic acid group as functional groups.

3. The electrolyte for a redox flow battery according to claim 1, wherein the amino acid compound comprises at least one of an amino acid and an amino acid derivative.

4. The electrolyte for a redox flow battery according to claim 3, wherein the amino acid is α-amino acid, β-amino acid, or γ-amino acid and the amino acid derivative is a derivative of the amino acid which has a substituent containing at least one element selected from the group consisting of nitrogen (N) and sulfur (S) at the side chain thereof through ionic bonding or covalent bonding.

5. The electrolyte for a redox flow battery according to claim 3, wherein the amino acid derivative is a hydrocarbon compound having an imidazole ring or a heteroaromatic ring including a C5-C9 aromatic ring, at least two carbon (C) atoms of which are substituted with at least one element selected from the group consisting of nitrogen (N), oxygen (O) and sulfur (S).

6. The electrolyte for a redox flow battery according to claim 5, wherein the heteroaromatic ring is pyrazolium, oxazolium, triazolium, thiazolium or pyrimidine.

7. The electrolyte for a redox flow battery according to claim 1, wherein the electrolyte is an electrolyte for a redox flow battery based on an aqueous or non-aqueous solvent and further comprising a metal ion active material or an organic molecule active material, and the additive forms a complex ion with the metal ion active material or organic molecule active material.

8. The electrolyte for a redox flow battery according to claim 7, wherein the organic molecule active material comprises at least one selected from the group consisting of flavin, a flavin derivative, a vitamin, a vitamin derivative, purine, a purine derivative, nicotinamide and phthalocyanine.

9. The electrolyte for a redox flow battery according to claim 8, wherein the flavin derivative is a compound of riboflavin, pteridine, isoalloxazine, alloxazine, lumichrome or lumazine, or the compound to which at least one heteroatom selected from the group consisting of carbon (C), nitrogen (N), oxygen (O) and sulfur (S) is attached through ionic bonding or covalent bonding.

10. The electrolyte for a redox flow battery according to claim 8, wherein the vitamin is vitamin A, vitamin B, vitamin C, vitamin D, vitamin E or vitamin K, and the vitamin derivative is the vitamin to which at least one heteroatom selected from the group consisting of carbon (C), nitrogen (N), oxygen (O) and sulfur (S) is attached through ionic bonding or covalent bonding.

11. The electrolyte for a redox flow battery according to claim 8, wherein the purine derivative is a purine to which at least one heteroatom selected from the group consisting of carbon (C), nitrogen (N), oxygen (O) and sulfur (S) is attached through ionic bonding or covalent bonding.

12. A method for preparing the electrolyte for a redox flow battery as defined in claim 1, comprising:
forming a first electrolyte in which an active material is dissolved; and
adding at least one additive selected from the group consisting of a taurine compound and an amino acid compound to the first electrolyte to form a second electrolyte.

13. The method for preparing the electrolyte for a redox flow battery according to claim 12, further comprising:
supplying the second electrolyte to a redox flow battery; and
charging or discharging the redox flow battery.

14. The method for preparing the electrolyte for a redox flow battery according to claim 13, wherein the redox flow battery is a unit cell, a half cell, a cell having asymmetric electrodes, a large-scale cell or a stack cell with large capacity.

15. The method for preparing the electrolyte for a redox flow battery according to claim 12, wherein the additive forms a complex ion with the active material in the second electrolyte.
